(19) United States
(12) Patent Application Publication
(10) Pub. No.: US 2018/0155936 A1
(43) Pub. Date: Jun. 7, 2018

(54) MOSAIC TILE

(71) Applicant: Mohawk Carpet, LLC, Calhoun, GA (US)

(72) Inventor: Lai Ning, Foshan City (CN)

(21) Appl. No.: 15/825,309

(22) Filed: Nov. 29, 2017

Related U.S. Application Data
(60) Provisional application No. 62/430,645, filed on Dec. 6, 2016.

(51) Int. Cl. E04F 15/10; B44C 3/12; E04F 13/08

(52) U.S. Cl. CPC E04F 15/105; E04F 13/0862; B44C 3/123

(57) ABSTRACT

A mosaic tile, comprising a plurality of subunits (2a-2b) adhered to a backing material (3), wherein at least some of said subunits (2a-2b) comprise thermoplastic material, or, more particularly consist of heterogeneous PVC tile parts.

### CROSS-REFERENCE TO RELATED APPLICATIONS

This patent application claims priority from provisional Patent Application Ser. No. 62/430,645, filed Dec. 6, 2016, which is incorporated herein by reference in its entirety.

### BACKGROUND

### Field of the Invention

The present description relates to mosaic tiles which may be usable for wall applications, but also for applications on other surfaces, such as floors or worktops.

### Description of Related Art

Mosaic tiles may comprise a plurality of ceramic subunits adhered to a backing material. Such mosaic tiles are for example illustrated in U.S. Pat. No. 8,539,736 B1. The subunits may be of variable shape, such as square, irregular, or elongated and rectangular. Examples of such shapes can be found in EP 2 933 118 A1, U.S. D740,452 S. In accordance with the prior art, the ceramic subunits carry a glaze of uniform color and are unstructured. Providing a sophisticated print on the small subunits is in most cases practically unfeasible. The technique of printing on ceramic tiles or tile parts intrinsically provides an inferior image, due to a choice of the inks that needs to be resistant to the high baking temperatures of the tile. Possibly subunits of several uniform colors may be combined on one mosaic tile.

With the aim of providing a prefabricated mix of subunits, U.S. Pat. No. 5,398,458 discloses the combination of subunits obtained from at least two natural stone slabs in one mosaic tile. Thereby an increase in shade variation is reached, as well as a solution to the possible risk of obtaining large shade differences between adjacent wall tiles containing subunits of only one, but mutually different natural stones. Natural stones are an expensive natural resource and the obtainable shade variation is limited.

The shape variation and possible shade variations in between subunits of a mosaic tile, as disclosed in the above discussed prior art, opens up multiple technical means for design options, but still leaves much to be desired.

### BRIEF SUMMARY

Various embodiments relate to a mosaic tile for wall, floor, and/or worktop applications, wherein in accordance with several embodiments one or more problems with the mosaic tiles of the state of the art have been alleviated or solved.

With this aim, the invention, in accordance with a first independent aspect thereof, relates to a mosaic tile (e.g., a wall tile), comprising a plurality of subunits adhered to a backing material, wherein at least some of said subunits comprise a plastic material (e.g., a thermoplastic material, a thermoset material, and/or the like). For example, a thermoplastic material may be chosen for at least some of said subunits from at least one of polyvinylchloride (PVC), polypropylene (PP), polyethylene (PE), polyethyleneterephtalate (PET), thermoplastic polyurethane (TPU), and/or the like. Such materials allow a multitude of techniques for shaping and decorating. Such thermoplastic materials can be made in larger slabs (e.g., via extrusion) and be divided, for example by punching or sawing, into said subunits. The shaping and decorating can be executed on the larger slabs, prior to division.

In certain embodiments, the thermoplastic material is polyvinylchloride (PVC). According to one embodiment of the present invention the relevant subunits comprise or consist of heterogeneous PVC (polyvinylchloride) tile parts. Heterogeneous PVC tile parts are parts that comprise a substrate layer (e.g., a filled substrate layer comprising at least one filler material) upon which a decoration (e.g., a printed decoration) is provided. Floor panels made from heterogeneous PVC are known as LVT or Luxury Vinyl Tile for example as disclosed in U.S. Pat. No. 8,728,603. The printed decoration may either be provided on a thermoplastic (e.g., PVC) or a foil, or the printed decoration may be provided by printing directly on the substrate layer with the possible intermediate of a ground layer, for example of uniform color. The substrate layer may comprise at least PVC. In certain embodiments, the PVC may be the main constituent of the substrate layer (e.g., excluding or including a filler material). Example filler materials comprise chalk, talcum or limestone, although other filler materials may be used. The filler content may range between 0 and 80% by weight of the substrate layer, and for example, is higher than 35%, or even higher than 50% by weight. The substrate layer may further comprise at least 10 PHR (parts per hundred resin) of a plasticizer. The plasticizer may be selected from at least one of DINCH (Diisononyl cyclohexane-1,2-dicarboxylate, such as that manufactured by BASF Corp. under the tradename Hexamoll DINCH), DINP (Diisononyl phthalate), DOTP (Dioctyl terephthalate) and/or soy bean based plasticizers, such as epoxidized soybean oil. For example, a mixture of DINCH and/or DINP with epoxidized soybean oil plasticizer may be utilized as a plasticizer. The latter possibility has extremely low emission of VOC (volatile organic components) and thus health risks associated to it are minimal. In certain embodiments, the decoration of the heterogeneous PVC tile part is provided with a transparent or translucent wear layer. Such wear layer may comprise a PVC layer, a polyurethane layer, and/or the like.

The use of heterogeneous PVC tile parts may be advantageous in mosaic tiles. The material is very water resistant and may be used in association with intricate decorative patterns. The exposed surface may be stain, abrasion, and/or scratch resistant. For example, the outermost layer of the subunits may comprise a radiation cured lacquer, such as an acrylic urethane lacquer, possibly comprising hard particles, such as aluminum oxide, that provides stain, abrasion, and/or scratch resistance. Such lacquer may be provided as a superficial layer with a thickness of below 0.1 mm on top of the wear layer, which may be, as afore stated, a transparent or translucent PVC layer with a thickness above 0.1 mm, or even above 0.2 mm.

In the case of a printed decoration, a digital printing technique may be used, for example with UV curing inks, solvent based inks and/or water based inks. The primer techniques described in WO 2015/140682 (which is incorporated herein by reference in its entirety) may be employed. As an alternative, conventional printing techniques may be used for the decoration, for example printing techniques employing rollers, such as rotogravure printing, either on a foil or directly on a substrate layer.

In certain embodiments, the heterogeneous PVC is firstly made in larger slabs, and then divided into said subunits. In various embodiments, the above described printing operations take part on such larger slabs, or on foils being larger than the subunits, for example on foils with a surface about equaling the size of the slab, or being larger than the slab.

In certain embodiments, the printed decoration resembles a wood grain. In such case subunits with the look of wood may be provided which are completely water resistant.

In certain embodiments, the plastic subunits (e.g., thermoplastic subunits) have a decorative surface with a relief formed therein. For example, the relief may be one of a wood grain, other wood features such as knots and cracks, or one of stone structure. In combination or not with such imitation of natural relief features, the subunits may comprise relief features such as depressed perimeters or parts thereof, for example in the shape of a beveled edge. The thermoplastic material readily allows for the provision of such features.

In the case of heterogeneous PVC tile parts, the relief features may be at least provided in an upper layer, such as in the wear layer, but may also have a depth larger than the thickness of the decoration and/or wear layers. In the latter case the internal upper surface of the substrate layer may be relieved.

In the case a printed decoration is used, such as may be the case with heterogeneous PVC tile parts, the relief at the decorative surface of the subunit may correspond to the printed decoration, such that a so-called relief-in-register is attained, leading to extremely realistic subunits. In the case of a printed wood grain decoration, the relief may comprise features imitating grain lines and/or wood pores at the location where such features are depicted in the decoration.

The subunits on one mosaic tile may be of varying nature, for example a mixture of ceramic subunits and thermoplastic, for example heterogeneous PVC, subunits. Thus, said plurality of subunits may also comprise ceramic tile parts.

According to a variant, all of said plurality of subunits on one mosaic tile comprise plastic material (e.g., a thermoplastic material), for example all heterogeneous PVC tile parts. In certain embodiments, the mosaic tile comprises exclusively subunits of plastic material of different nature, (e.g., the subunits may not all comprise heterogeneous PVC tile parts).

Other possibilities for the plastic subunits on the mosaic tile of the invention are subunits comprised of homogeneous PVC tile parts. These subunits may be essentially composed of a PVC substrate layer, which may also form at least part of the decoration aspect of the part. Such subunits may be free from a decoration layer that covers the entirety of the substrate layer, or even free from any kind of decoration layer. Such homogeneous PVC is used as a floor covering material and is also known as VCT or vinyl composition tile, for example as discussed in US 2005/146069 and/or US 2008/119604.

In certain embodiments, said backing material comprises a mat, film, mesh, net, scrim, maze, and/or the like. The backing material may comprise any of a plurality of materials, such as fiberglass, natural fibers, plastic fibers, non-woven materials, and/or the like. Such mat, film, mesh, net, scrim, maze, and/or the like may be configured to keep the subunits together by being adhered, for example with a hotmelt glue, to the back of the subunits.

In certain embodiments, said backing material comprises an adhesive layer, for example at the side opposite the subunits. The adhesive layer may be covered by a removable protective layer, which may be removed upon installation of the mosaic tiles.

In certain embodiments, said plurality of subunits are arranged in a pattern, such as in a chess pattern, a brick pattern, and/or the like.

In certain embodiments, the plurality of subunits defines a boundary that comprises at least two opposing staggered edges. The staggered edge may be complimentary to one another, such that when installing two of such mosaic tiles adjacent to one another the opposite staggered edges interleave or match into each other. In such case the boundary of the mosaic tiles may be visually hidden in the final installation, thereby creating the look of a mosaic wall made from separated subunits, instead of from mosaic tiles comprising each of several subunits adhered to a common backing material.

The plurality of subunits may comprise square and or hexagon shaped tile parts.

The plurality of subunits may comprise elongated rectangular tile parts.

In certain embodiments, the plurality of subunits all have about the same shape.

In certain embodiments, said subunits are spaced apart on said backing material. Such spacing may serve to accommodate a grouting material, either cement based or polymer based. Such spacing, together with the grouting material or not, may also serve to accommodate dimensional changes in the subunits or backing material.

With the same aim, the invention, in accordance with a second independent aspect thereof, also relates to a mosaic tile unit comprising at least a plurality of subunits, wherein said plurality of subunits comprises nonplastic subunits (e.g., ceramic subunits) and plastic subunits (e.g., thermoplastic subunits), wherein the plastic subunits may comprise heterogeneous PVC tile parts. The subunits may form a mosaic tile unit by being adhered to a common backing material, or by being otherwise united, for example by being disposed in a common receptor tray. In certain embodiments, the mosaic tile units of the second aspect may show the characteristics of the mosaic tile of various embodiments, as long as they are not contradictory.

### BRIEF DESCRIPTION OF THE SEVERAL VIEWS OF THE DRAWINGS

Reference will now be made to the accompanying drawings, which are not necessarily drawn to scale, and wherein:

FIG. 1 represents an example of a mosaic tile with the characteristics of the invention;

FIG. 2 represent a cross-section along the line II-II indicated in FIG. 1;

FIG. 3 in a similar view as FIG. 2 represents a variant; and

FIG. 4 in a similar view as FIG. 1 represents a variant

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

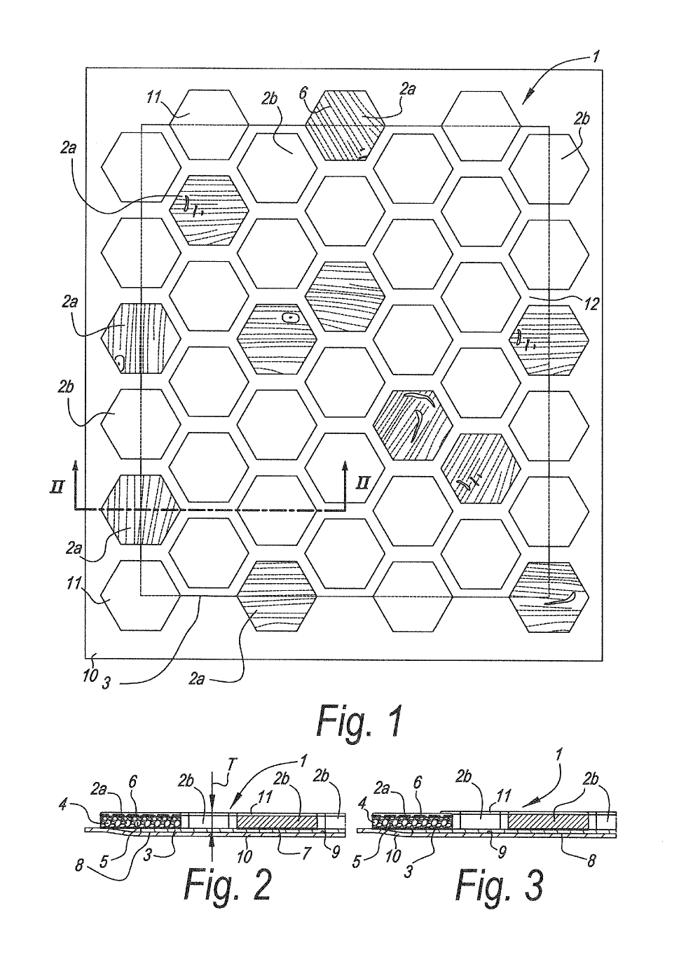

FIG. 1 shows a mosaic tile 1 according to one embodiment. The tile 1 comprises a plurality of subunits, including plastic subunits 2a and nonplastic subunits 2b adhered to a backing material 3. In certain embodiments, the plastic subunits 2a comprise thermoplastic material 4 (e.g., PVC, PP, PE, PET, TPU), and/or the like, while the subunits 2b comprise ceramic tile parts. However, it should be understood that in certain embodiments, the plastic subunits 2a may comprise other plastic materials, such as thermoset plastics, and the nonplastic subunits 2b may comprise other nonplastic materials, such as natural stone, manufactured hard surfaces, and/or the like.

In the illustrated example embodiment of FIG. 2, the plastic subunits 2a comprise a thermoplastic material 4, specifically comprising (e.g., consisting of) heterogeneous PVC tile parts. The plastic subunits 2a comprise a substrate layer 5 upon which a printed decoration 6 is provided. In the illustrated embodiment, the printed decoration 6 resembles a wood grain, although it should be understood that other decorations, patterns, images, and/or the like may be provided. Moreover, the substrate layer 5 may include a reinforcement layer, such as a glass fiber layer (not shown in the figures).

Moreover, as shown in FIGS. 1-3, the nonplastic subunits 2b comprise ceramic subunits. The ceramic subunits may be preformed in the desired shape, for example, by forming and baking the ceramic material in the desired shape of the nonplastic subunits 2b. However, it should be understood that the nonplastic subunits 2b may be formed by cutting individual the nonplastic subunits 2b into a desired shape, for example, from a natural or manufactured stone or other hard surface material.

In certain embodiments, the thickness T of the plastic subunits 2a and nonplastic subunits 2b may be between 3 and 10 mm, for example, between 4 and 7 mm. According to the example of FIG. 2, the plastic subunits 2a have at least approximately the same thickness T as the nonplastic subunits 2b. According to the example of FIG. 3 the nonplastic subunits 2b (e.g., formed of ceramic tile parts) may have a larger thickness T than the plastic subunits 2a formed of thermoplastic material, or vice versa, such that a three-dimensional structure is obtained at the surface of the mosaic tile 1. The difference in thickness T between the plastic subunits 2a and the nonplastic subunits 2b may be slight, for example the difference in thickness may be less than 5 millimeters such as less than 3 millimeters or less than 2 millimeters.

The subunits making up the mosaic tiles of FIGS. 1-3 may be secured (e.g., adhered) to a backing material 3 using a glue 7 or other adhesive, such as an epoxy adhesive, a thermoplastic adhesive, a thermoset adhesive, a water-based adhesive, and/or the like. The backing material 3 may comprise a mat, film, mesh, net, scrim, maze and/or the like and may comprise a fiberglass material, a plastic material (e.g., a plastic fiber material), a natural fiber material, and/or the like. In the illustrated embodiments, the backing material 3 defines an at least substantially continuous sheet, such that a plurality of subunits (e.g., plastic subunits 2a and/or nonplastic subunits 2b) secured relative to a single backing material 3 sheet are secured relative to one another.

As represented, the backing material 3 at its rear side 8 has self-adhering properties due to an adhesive layer 9 (e.g., comprising a pressure sensitive adhesive) present at said rear side 8 or the side opposite the subunits. The adhesive layer 9 is covered with a removable protective layer 10. The adhesive layer 9 may be a separate layer, such as an adhesive film, an adhesive spray, and/or the like that may secured relative to the backing material 3. In other embodiments, the backing material 3 itself may comprise adhesive properties, at least on a backside of the backing material 3.

In the illustrated example of FIG. 1, the subunits 2a-2b may all be hexagon shaped, for example, having the same size and arranged in a honeycomb pattern. However it should be understood that the subunits 2a-2b may have any of a variety of shapes. The distribution of the subunits of differing material is random in the example, but may be showing a predetermined motif as well.

As shown in FIG. 1, the hexagon shape of the subunits 2a-2b may create a staggered edge profile surrounding at least a portion of the perimeter of the mosaic tile. The staggered edge profile may be complementary with other tiles placed adjacent to the mosaic tile, such that the staggered edges of adjacent tiles interleave with one another to visually providing the look of a continuous mosaic tile encompassing subunits disposed within a plurality of individual mosaic tiles having the configuration described herein. In certain embodiments, individual subunits 2a, 2b defining the staggered edge profile may be secured relative to the backing material 3, and may extend beyond edges of the backing material 3 to enable the staggered edges of adjacent tiles to be interleaved with one another, such that the individual subunits 2a, 2b at the perimeter of adjacent mosaic tiles may be spaced at a distance at least substantially equal to the spacing distance between subunits 2a, 2b of a single mosaic tile. By enabling consistent spacing both between subunits 2a, 2b on a single mosaic tile as well as between adjacent mosaic tiles, the mosaic tile configuration may provide the visual look of a continuous mosaic tile comprising a plurality of subunits 2a, 2b disposed within individual mosaic tiles.

FIG. 1 also shows the printed decoration 6 may show varying orientations of the wood grain pattern, e.g., for some of the plastic subunits 2a aligned to the main directions of the mosaic tile 1 and some not aligned.

The nonplastic subunits 2b may be free from patterns, and may comprise a top surface formed from a uniformly colored glaze 11.

The subunits 2a-2b may be spaced apart on the backing material 3. The spacing 12 may serve to accommodate a grouting material.

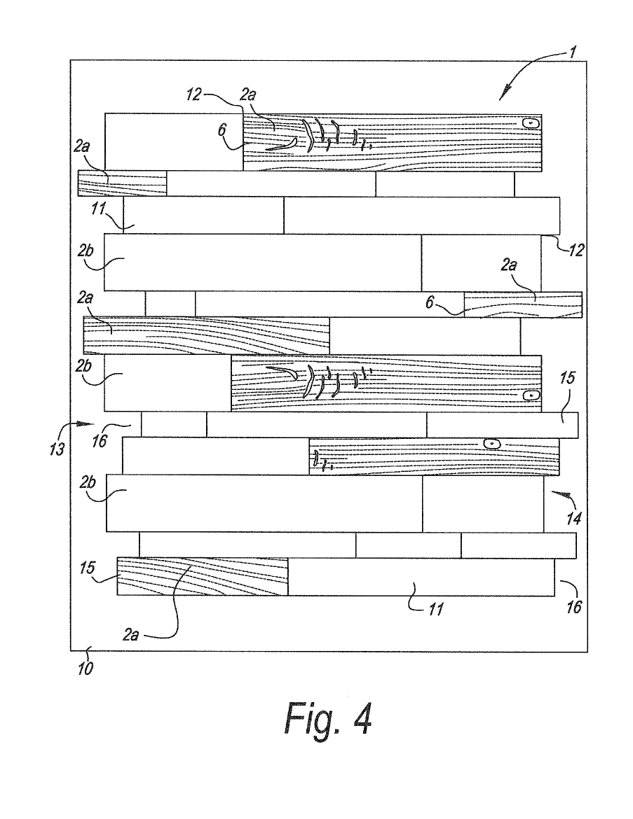

FIG. 4 illustrates another example of a mosaic tile in accordance with the invention. Herein the subunits 2a-2b comprise elongated rectangular parts. The plastic subunits 2a may comprise heterogeneous PVC tile parts, and the nonplastic subunits 2b may comprise ceramic tile parts. Although other materials may be utilized, as noted with respect to FIG. 1, above.

The subunits 2a-2b shown in the example of FIG. 4 are only minimally spaced apart, e.g., the spacing is less than half, or even less than a third of the thickness of the subunits 2a formed from thermoplastic material.

The embodiment shown in FIG. 4 is such that the boundary of the subunits 2a-2b comprises two opposing staggered edges 13-14, which are complementary to each other. The protruding parts 15 of one of said edges 13-14 can enter the spaces 16 formed at the opposing one of said edges 13-14.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mosaic tile comprising:
a backing material sheet; and
a plurality of subunits secured to the backing material sheet, wherein the plurality of subunits comprise:
a plurality of plastic subunits; and
a plurality of non-plastic subunits.

2. The mosaic tile of claim 1, wherein each of the plurality of plastic subunits are defined as thermoplastic subunits.

3. The mosaic tile of claim 2, wherein said thermoplastic subunits each comprise a heterogeneous polyvinylchloride material.

4. The mosaic tile of claim 3, wherein said thermoplastic subunits comprise a substrate layer having a printed decoration thereon.

5. The mosaic tile of claim 1, wherein each of the plurality of non-plastic subunits are defined as ceramic subunits.

6. The mosaic tile of claim 1, wherein each of the plurality of non-plastic subunits are defined as natural stone subunits.

7. The mosaic tile of claim 1, wherein:
each of the plurality of plastic subunits are defined as thermoplastic subunits; and
each of the plurality of non-plastic subunits are defined as ceramic subunits.

8. The mosaic tile of claim 7, wherein each of the plurality of plastic subunits has a first thickness, and each of the plurality of non-plastic subunits has a second thickness, and wherein the first thickness is at least substantially equal to the second thickness.

9. The mosaic tile of claim 7, wherein said thermoplastic subunits each comprise a heterogeneous polyvinylchloride material.

10. The mosaic tile of claim 1, wherein the backing material sheet comprises one of: a mat, a film, a mesh, a net, a scrim, or a maze.

11. The mosaic tile of claim 1, wherein the backing material sheet comprises an adhesive layer adhering the plurality of subunits onto the backing material sheet.

12. The mosaic tile of claim 1, wherein the plurality of subunits collectively define at least two opposing staggered edges configured to interleave with adjacent mosaic tiles.

13. A mosaic tile comprising:
a plurality of tile subunits secured relative to one another, wherein the plurality of tile subunits comprise:
a plurality of thermoplastic subunits; and
a plurality of ceramic subunits.

14. The mosaic tile of claim 13, wherein said thermoplastic subunits each comprise a heterogeneous polyvinylchloride material.

15. The mosaic tile of claim 14, wherein said thermoplastic subunits comprise a substrate layer have a printed decoration thereon.

16. The mosaic tile of claim 15, wherein the substrate layer defines a plurality of decorative reliefs therein.

17. The mosaic tile of claim 13, wherein the plurality of subunits are secured to a common backing material sheet such that the plurality of subunits are secured relative to one another.

18. The mosaic tile of claim 13, wherein the plurality of subunits are disposed in a common receptor tray.

19. The mosaic tile of claim 13, wherein each of the plurality of thermoplastic subunits has a first thickness, and each of the plurality of non-plastic subunits has a second thickness, and wherein the first thickness is at least substantially equal to the second thickness.

20. The mosaic tile of claim 13, wherein the plurality of subunits collectively define at least two opposing staggered edges configured to interleave with adjacent mosaic tiles.
